(19) United States
(12) Patent Application Publication
(10) Pub. No.: US 2022/0314644 A1
(43) Pub. Date: Oct. 6, 2022

(54) INDEPENDENTLY-CONTROLLED PRINT HEAT SOURCES

(71) Applicant: Hewlett-Packard Development Company, L.P., Spring, TX (US)

(72) Inventors: Richard Lee Brinkly, Vancouver, WA (US); Duane A. Koehler, Vancouver, WA (US)

(73) Assignee: Hewlett-Packard Development Company, L.P., Spring, TX (US)

(21) Appl. No.: 17/630,682

(22) PCT Filed: Aug. 9, 2019
(86) PCT No.: PCT/US2019/045959

§ 371 Date: Jan. 27, 2022

(51) Int. Cl. B41J 11/00

(52) U.S. Cl. CPC B41J 11/002

(57) ABSTRACT

In one example in accordance with the present disclosure, a print system is described. The print system includes a drive roller Print System and a heated transfer belt forming a nip with the drive roller. The heated transfer belt transmits thermal energy to print media passing through the nip. The print system also includes multiple independently-controlled heat sources disposed within the heated transfer belt to transfer thermal energy to the heated transfer belt.

### BACKGROUND

Printing is the operation of forming images, text, and/or any other characters or patterns on print media. The print compound used to form the patterns on the print media may be wet or dry. Print systems may also include supplemental devices that perform operations, such as finishing operations, on the print media following printing. For example, a system may staple and fold the media after it has been printed on.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a print system with independently-controlled print heat sources, according to an example of the principles described herein.

FIG. 2 is a side view of a print media conditioning system with independently-controlled print heat sources, according to an example of the principles described herein.

FIG. 3 is a flow chart of a method for independently controlling print heat sources, according to an example of the principles described herein.

FIG. 4 is an isometric view of a print system with independently-controlled print heat sources, according to an example of the principles described herein.

FIG. 5 is an isometric view of a print system with independently-controlled print heat sources, according to another example of the principles described herein.

FIG. 6 is a diagram depicting independently controlling print heat sources, according to an example of the principles described herein.

FIG. 7 is a flow chart of a method for independently controlling print heat sources, according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

As described above, printing refers to a process wherein images and/or text are formed on print media such as paper. A variety of printing methods exist, the different methods using different types of print compound. For example, the print compound may be a liquid. An inkjet printer may use liquid print compound, which may be referred to as ink. In this example, the inkjet printer includes a number of printheads which eject small droplets of the ink. In some examples, the printhead moves relative to the print media, in other examples the printhead is stationary. In either example, the small droplets form the image/characters on the print media.

Another example of a printer is a laser printer which uses dry compound, sometimes referred to as toner, to form the images/characters. In this example, an electrostatic template of the desired image/characters is formed on a rotating drum that has an electrical charge. A cartridge dispenses the toner, but just those portions of the drum that have a charge retain deposited toner. This toner is then transferred to the print media as it comes into contact with the drum.

In either case, a heat source is used in the print process. For example, when toner is used, the applied dry toner is fused onto the print media. In this example, the heat source is used to heat the dry toner past its fusing temperature such that it fuses together and onto the print media.

In the case of liquid print compound, the print media may be subject to any number of finishing operations, such as stacking, stapling, collating, etc. In some examples, the liquid on the print media may affect how the print media responds to handling. For example, the addition of the liquid print compound to the media causes the media fibers to rise up, which can cause a sheet of print media to stick to another sheet of print media, for example as sheets of media are stacked in an output tray. Moreover, if the liquid compound is not fully dry, it may smear, thus causing the images/characters to smear.

In this example, a heat source may be used to dry the liquid compound, which in part causes the media fibers to re-settle and thus be less prone to sticking and/or catching on other media. Moreover, the liquid compound dries, thus becoming less prone to smearing. In summary, ink printed media is desired to be conditioned and dried after the printing process for handling and further processing.

Use of a single heat source of pre-decided capacity (power) is ineffective. Specifically, a controller changes the amount of effective current by passing pulses through the heat source. In these examples, the heat source is sized such that it can supply the maximum amount of total power that may be desired for the highest predicted amount of supplied heat. This may result in a large heat source with large amounts of heat energy being generated in short periods of time. This may cause over drying, which is also undesirable. For example, if too much moisture is taken out of the liquid print compound, especially on one side of the print media, a difference in moisture content may result as compared to the other side of media, causing the pages to curl.

Curling pages is also undesirable in subsequent finishing operations. For example, one sheet of media may slide under another, or may push, catch edge of, and/or lift up another sheet of media such that the media cannot be properly stacked. Other negative impacts on print media finishing are also possible,

To prevent overheating, the heat source may be cycled on and off very quickly using pulse-width modulation (PWM). If the PWM duty cycle is too short, damage to the heat source is possible. For example, halogen lamp heat sources include an element that has to reach a sufficient temperature to enable the “halogen cycle” or element re-plating in the presence of a halogen gas. Every time the lamp is turned on and off, a current surge occurs on the AC input current to the printer. Each current surge creates a voltage droop on the building's AC circuit. These voltage droops can cause visible flicker in room lighting, and have other adverse effects to other AC loads. The short duration of “on” vs “off” can also result in poor thermal control of the heating source. In some cases, the lamp control system uses “half-cycle control”, which applies energy to the lamp for an integer number of AC half-cycles in succession, then removes power for a subsequent integer number of half-cycles. Thus, the lamp on-off period is relatively slow (less than 100 Hz). Accordingly, the heating source may cool down too much between application of power pulses.

Moreover, different print characteristics dictate different heating treatments. That is, some application of heating can necessitate a very precise heating temperature to prevent over drying, under drying, or undesirable media shape changes. A single heat source may not be able to provide such a fine-tuned heating environment.

Accordingly, the present systems and methods apply heat using an apparatus that allows for finer resolution of heating capability. Specifically, the present systems and methods describe a heating system that is variable and that is adjusted based on the amount and position of print compound deposited upon a sheet of media. By controlling the amount of heat discretely, a more efficient use of power and longevity of the heating system can be achieved.

Specifically, the present specification describes a print system. The print system includes a drive roller and a heated transfer belt forming a nip with the drive roller. The heated transfer belt transmits thermal energy to print media passing through the nip. The print system also includes multiple independently-controlled heat sources disposed within the heated transfer belt to transfer thermal energy to the heated transfer belt.

The present specification also describes a method. According to the method, characteristics of print media passing through a nip between the drive roller and the heated transfer belt are determined. An amount of thermal energy to apply to the print media is determined based on the determined characteristics. A combination of multiple independently-controlled heat sources are activated to supply the determined amount of thermal energy.

The present specification also describes a print media conditioning system. The print media conditioning system includes a drive roller and a heated transfer belt forming a nip with the drive roller. The heated transfer belt to transmit thermal energy to print media passing through the nip to dry liquid print compound on the print media. The print media conditioning system also includes multiple independently-controlled heat sources of varying emitting energy values disposed within the heated transfer belt to transfer thermal energy to the heated transfer belt. A support member is disposed within the heated transfer belt onto which the multiple independently-controlled heat sources are mounted. The print media conditioning system also includes a lookup table to map characteristics of the print media to amounts of thermal energy to apply to the print media. A controller of the print media conditioning system 1) determines an amount of thermal energy to apply to the print media based on characteristics of the print media and 2) determines what combination of the multiple independently-controlled heat sources to activate to supply the determined amount of thermal energy.

Such systems and methods 1) reduce electrical flicker (i.e., cycling on/off); 2) enhance energy efficiency; 3) increase heat source life; 4) reduce over drying of print media causing undesired media curl; 5) provides a simple power control using discrete heat sources; 6) facilitates multiple quantized power levels achieved in fixed increments; 7) provides predetermined output levels; 8) are customizable to the specific characteristics of the input media content; 9) can continue operation in event of a single heat source failure; and 10) can be used with a variety of heat sources.

As used in the present specification the term “print compound” refers to a compound that is deposited on a media, such as a sheet of paper, to form the images, text, or other patterns. Print compound may be wet. For example, the print compound may be ink. Print compound may be dry. For example, the print compound may be toner.

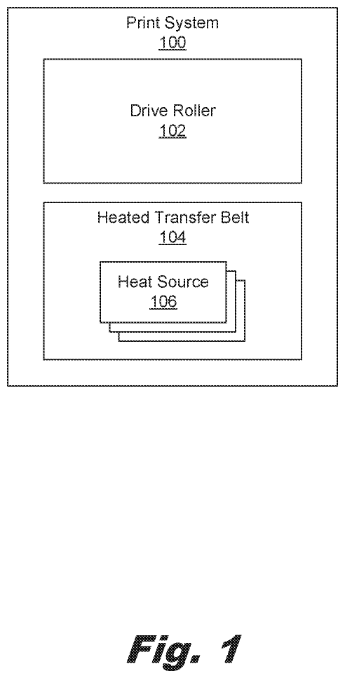

Turning now to the figures, FIG. 1 is a block diagram of a print system (100) with independently-controlled print heat sources (106), according to an example of the principles described herein. As described above, the print system (100) may be used at a variety of stages of a variety of different printers. For example, in a toner printer, the print system (100) may be used to heat and fuse the toner to the print media, In the example of a liquid printer, the print system (100) may be used to condition the print media after printing, but before it passes to a finisher to perform any number of finishing operations.

The print system (100) includes a drive roller (102). The drive roller (102) is a mechanism that transports the print media. The print system (100) also includes a heated thermal transfer belt (104) that forms a nip with the drive roller (102). The drive roller (102) and the heated thermal transfer belt (104) rotate and pull media through the nip to other components of the printer. This heated transfer belt (104) also transmits thermal energy to print media passing through the nip. As described above, this thermal energy may be applied to fuse dry print compound to print media or to dry liquid print compound on the media.

The print system (100) also includes multiple independently-controlled heat sources (106) disposed within the heated transfer belt (104) to transfer thermal energy to the heated transfer belt (104). That is, the thermal heat that fuses dry toner or that dries liquid ink is generated by the independently-controlled heat sources (106). The independently-controlled heat sources (106) may have different emitting energy values. For example, a first heat source (106) may be a 100-Watt halogen lamp, a second heat source (106) may be a 200-Watt halogen lamp, a third heat source (106) may be a 400-Watt halogen lamp, and a fourth heat source (106) may be an 800-Watt halogen lamp. Being that each are independently-controlled, any combination of the different heat sources (106) may be activated to generate an overall thermal energy. For example, given the specific halogen lamps described above, overall thermal values ranging from 100 to 1500 Watts could be generated by activating different combinations of the heat sources (106). Thus, the present print system (100) provides a configuration of multiple independent heat sources (106), in parallel such that the energy of the heat sources (106) may be imparted upon the sheet of media. The form of heat transfer can be of any type, including radiative, convective, conductive, or inductive heat transfer. Such a print system (100) may operate on any type of print media.

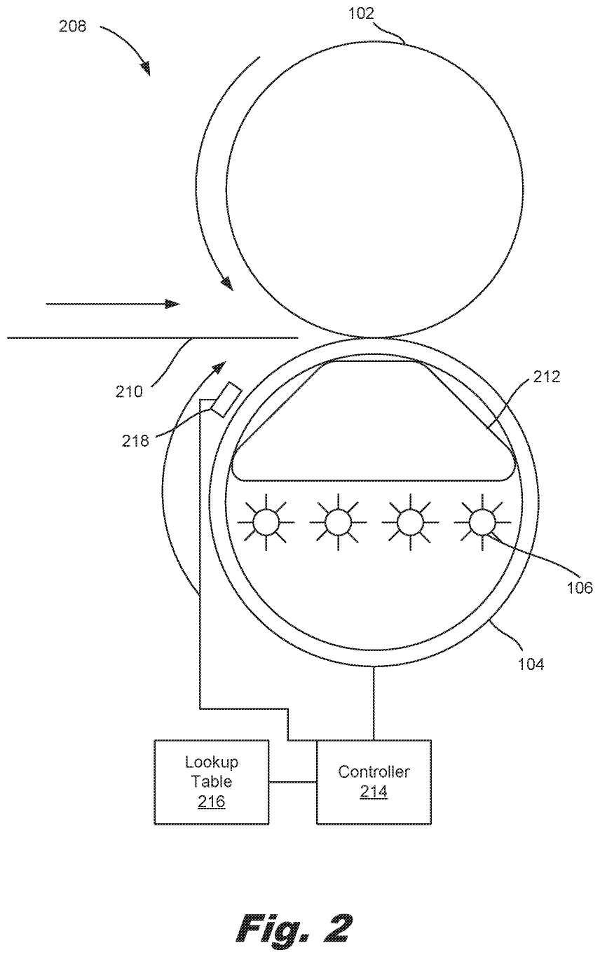

FIG. 2 is a side view of a print media conditioning system (208) with independently-controlled print heat sources (106), according to an example of the principles described herein. As described above, the print system (FIG. 1, 100) may be included in a conditioning subsystem of a printer, in which case the print system (FIG. 1, 100) may be referred to as a print media conditioning system (208). FIG. 2 depicts the drive roller (102), the heated transfer belt (104), and the nip formed therein. In this example, the heated transfer belt (104) is to dry liquid print compound on the print media (210) as it passes through the nip. That is, the driver roller (102) and the heated transfer belt (104) rotate as indicated in FIG. 2 and in so doing draw print media (210) through the nip to be pressed between the drive roller (102) and the heated transfer belt (104).

FIG. 2 also depicts the multiple independently-controlled heat sources (106) of varying emitting energy values that are disposed within the heated transfer belt (104) to transfer thermal energy to the heated transfer belt (104). For simplicity, a single heat source (106) is indicated in FIG. 2 with a reference number. The combination of heat from the heated transfer belt (104) and the pressure exerted at the nip may cause the print media (210) to flatten and not be as susceptible to the potentially negative effects of the liquid ink on the print media (210). Moreover, by including independently-controlled heat sources (106) of varying emitting energy values, higher resolution thermal energy increments are provided such that a more tailored and specific thermal energy is applied. This alleviates any complications that may arise from overheating or underheating as is the case with a single heat source system.

The print media conditioning system (208) also includes a support member (212) disposed within the heated transfer belt (104). This support member (212) provides a fixed surface to hold the heated transfer belt (104) in place as the drive roller (102) presses against it. The support member (212) also provides a mounting surface for the multiple independently-controlled heat sources (106).

The heated transfer belt (104) may be formed of various components. For example, the heated transfer belt (104) may include a metallic tube that is coated on an outside diameter with a material with a low coefficient of friction, such as polytetrafluoroethylene (PTFE) or another polymer. This prevents the print media (210) and any liquid print compound disposed thereon, from sticking to the heated transfer belt (104) which could impact subsequent print operations. The heated transfer belt (104) may be lined on an inside diameter with a rubber material, so as to absorb evenly the heat emitted by the heat sources (106). As described above, the heated transfer belt (104) may be a stiff roller. However, in other examples, the heated transfer belt (104) may be a flexible tube that deflects or deforms slightly due to the pressure against the drive roller (102).

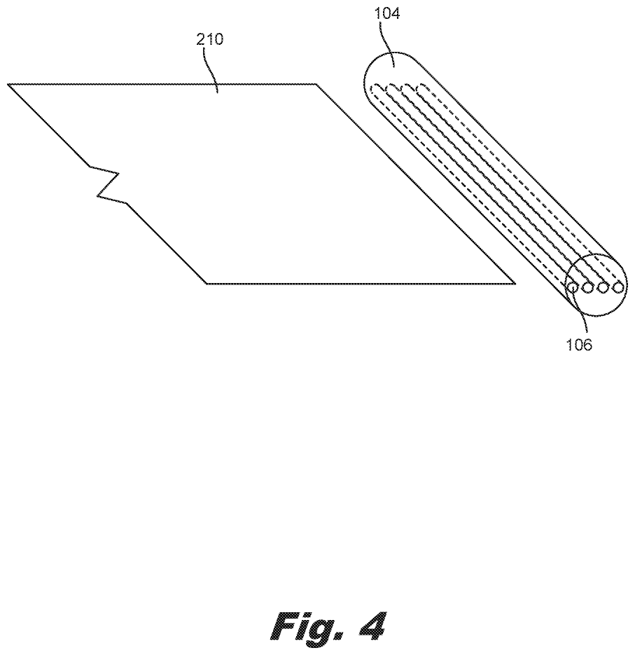

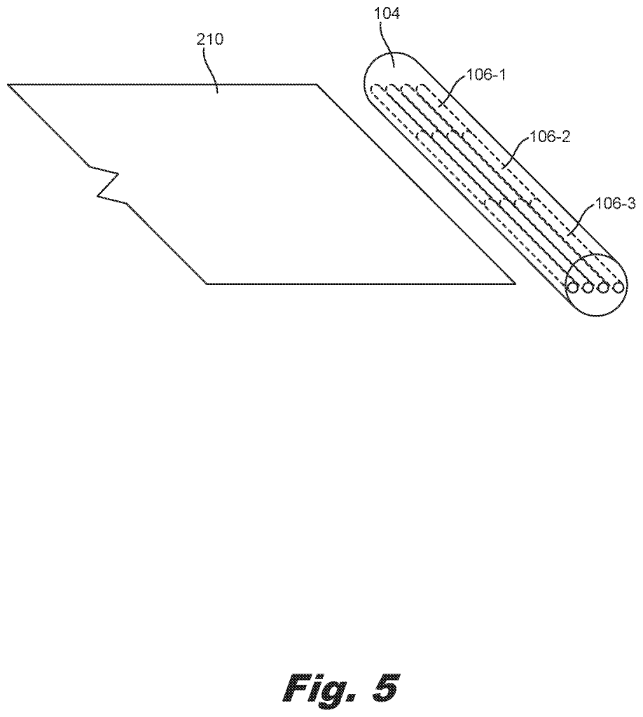

As described above, the heat sources (106) may be of a variety of types. In the example depicted in FIG. 2, radiation heat transfer is used in the form of a set of halogen lamps. The halogen lamps may fully or partially expose the expected width of a print media (210) sheet. That is, the lamps may extend across a width of the drive roller (102) and the heated transfer belt (104) as depicted in FIGS. 4 and 5. As described above, the lamp powers may be arranged to be of a “4 bit” configuration in powers of 100, 200, 400, and 800 Watts. Using a single heat source (106) or multiple heat sources (106) results in different levels of heating power output.

In some examples, the heat sources (106) may be arranged in a particular fashion. For example, the heat sources (106) emit energy towards the heated transfer belt (104). As the heated transfer belt (104) rotates, it loses heat via radiation to the surrounding environment. Accordingly, the independently-controlled heat source (106) with a largest emitting energy value is farthest away from the nip relative to other independently-controlled heat sources (106).

The print media condition system (208) also includes a controller (214). The controller (214) determines an amount of thermal energy to apply to the print media (210) based on characteristics of the print media (210). That is, different characteristics of the print media (210) may lead to different heating conditions. For example, thicker media may be heated more to dry the liquid print compound as compared to thinner media (210). In another example, higher concentrations of liquid print compound be heated to a hotter temperature to ensure proper drying. Other examples of characteristics of the print media (210) that are determined include a print media type, a print compound type, an amount of print compound deposited, and a location on the print media (210) where the print compound is deposited. Some of these characteristics may be determined based on user input. For example, a user may input the type of media printed on. Some of these characteristics may be determined based on sensors within the system. For example, an optical sensor may determine a location on the print media where the print compound is deposited. As yet another example, the printer may have stored the print compound type that is used by the printer, and thereby applied to the print media (210). As yet another example, the printer in which the print media conditioning system (208) is disposed may perform drop counting. That is, the printer may detect which ejection resistors are firing and may know how much fluid reaches the print media (210) per ejection.

In yet another example, the characteristics may be determined via an electronic analysis of the print job. For example, the print job, as received from a computing device can be analyzed. From this analysis, the print characteristics such as quantity of print compound and location of print compound, may be made and used by the controller (214) to control the heat sources (106).

From these print media (210) characteristics, an amount of thermal energy to apply is determined. To make such a determination, the print media conditioning system (208) includes a lookup table (216) that maps characteristics of the print media (210) to amounts of thermal energy to apply to the print media (210). That is, information, either from a user, from an electronic analysis of the print job, or from sensors on the printer, is passed to the controller (214). The lookup table (216) maps this same information to a value indicating a thermal energy to apply to the print media (210). The controller (214) then determines what combination of the multiple independently-controlled heat sources (106) to activate to supply the determined amount of thermal energy.

In some examples, the lookup table (216) is based on environmental conditions of the printer. That is, due to temperatures and humidity in the printing environment, drying rates may differ such that different amounts of heat are selected to be applied to effectuate a desired moisture removal rate. As yet another example, the humidity in a room may affect heat loss between the heat sources (106), the heated transfer belt (104), and the print media (210). Thus, different heating values may be selected based on the particular environmental conditions in which printing occurs.

The lookup table (216) may also account for a time delay between when the print media (210) is printed on and when the print media (210) passes through the nip of the print media conditioning system (208). That is, in the time between when print media (210) is printed on and when the print media (210) passes through the nip, the liquid print compound may have already begun to dry. The lookup table (216) may account for this, for example, by suggesting a lower thermal energy be applied as compared to what is desired to account for any natural drying.

In some examples, the lookup table (216) is based on experimental data that characterizes the quantity and location of the liquid print compound. The lookup table (216) also accounts for the media type as entered by the user and includes correction factors for humidity and ambient temperature.

In some examples, such determinations are made multiple times for a sheet of print media (210). That is, the same characteristic, such as a particular amount of liquid print compound, may justify different amounts of thermal energy application based on whether it's a leading edge of a sheet of print media (210) or a trailing edge of a sheet of print media (210), Accordingly, the controller (214) selectively activates particular heat sources (106) per subsections of a sheet of print media (210).

In some examples, the controller (214) operates in consideration of certain operational criteria. For example, the controller (214) may determine how much thermal energy to apply considering constraints of flicker reduction, electro-magnetic compatibility of the product, or similar system criteria.

In some examples, a temperature sensor (218) is included to measure an applied thermal energy. That is, as described above, between when heat sources (106) are activated and when the print media (210) portion, which was used to trigger activation of the particular combination of heat sources (106), reaches the nip, heat loss may occur. Accordingly, less than a desired amount of thermal energy may be applied at the nip. Based on output from the temperature sensor (218), the controller (214) may adjust its operation, and/or the lookup table (216) may be updated. That is, the temperature sensor (218) provides a closed loop feedback environment to ensure a desired amount of thermal energy is actually applied to the print media (210) as it passes through the nip. In some examples, the temperature sensor (218) may be disposed at the nip. However, in other examples, the temperature sensor (218) may be placed at other locations along the heated transfer belt (104).

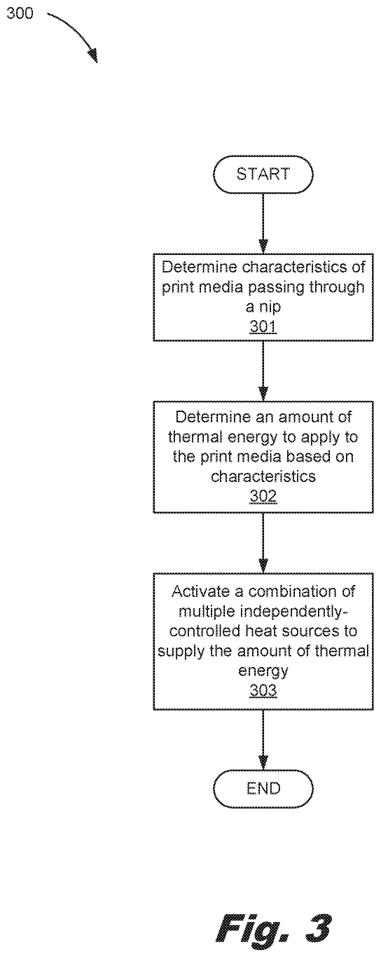

FIG. 3 is a flow chart of a method (300) for independently controlling print heat sources (FIG. 1, 106), according to an example of the principles described herein. According to the method (300), characteristics of print media (FIG. 2, 210) passing through a nip between a drive roller (FIG. 1, 102) and a heated transfer belt (FIG. 1, 104) are determined (block 301). Such a determination may be made before the print media (FIG. 2, 210) reaches the print media conditioning system (FIG. 2, 208), such as just after printing. As described above, characteristics of the print media (FIG. 2, 210) change how the print media (FIG. 2, 210) is subsequently handled. Examples of such characteristics include print media type, location of print compound, type of print compound, and an amount of print compound deposited. This information may be collected from any number of sources including from a user of the printer and/or the printer itself.

The controller (FIG. 2, 214) also determines (block 302) the amount of thermal energy to apply to the print media (FIG. 2, 210) based on the determined characteristics. As described above, this may be done by referencing a lookup table (FIG. 2, 216) that includes a mapping between print media (FIG. 2, 210) characteristics and thermal energy values to apply. Also as described above, such a determination (block 302) may be made to account for environmental conditions in which the printer is found and a time delay between printing and media conditioning. This adjustment for environmental conditions and time delay may be effectuated at the controller (FIG. 2, 214) which may adjust the thermal energy value obtained from the lookup table (FIG. 2, 216) based on the environmental conditions and time delay or may be effectuated at the lookup table (FIG. 2, 216) which accounts for the environmental conditions and time delay in the mapping.

In either example, the controller (FIG. 2, 214) activates (block 303) a combination of multiple independently-controlled heat sources (FIG. 1, 106) to supply the determined amount of thermal energy. In some examples, each heat source (FIG. 1, 106) may be pulse-width modulated. This may be done to provide even finer thermal control resolution or so that the application of power to the heat sources is time-multiplexed, in order to reduce AC line flicker or reduce EMC emissions from the printing system. As described above, the method (300) may be performed at a resolution of less than a sheet. That is, characteristics may be determined (block 301), thermal energy to apply may be determined (block 302), and corresponding heat sources (FIG. 1, 106) activated (block 303) on sub-sections of a sheet of media.

FIG. 4 is an isometric view of a print system with independently-controlled print heat sources (106), according to an example of the principles described herein. In this example, each independently-controlled heat source (106) extends a width of the heated transfer belt (104) in a direction perpendicular to a media path. That is, each of the different heat sources (106) applies thermal energy to the entire width of the print media (210).

FIG. 5 is an isometric view of a print system with independently-controlled print heat sources (106), according to an example of the principles described herein. In this example, multiple independently-controlled heat source's (106-1, 106-2, 106-3) combined length extends a width of the heated transfer belt (104) in a direction perpendicular to a media path. Doing so provides for not only the length-wise (i.e., parallel to the media path) sectional treatment of a print media (210), but a width-wise (i.e., perpendicular to the media path) sectional treatment of a print media. While FIG. 5 depicts three heat sources (106) that extend along a width of the print media (210), any number of heat source (106) may be arranged longitudinally to match the length of the heated transfer belt (104).

As described above, different heat sources (106) may have different emitting energy values. For example, during conditioning, the outer heat sources (106-1, 106-2) may be turned higher to account for thermal bleed of the applied thermal energy off the sheet of print media (210).

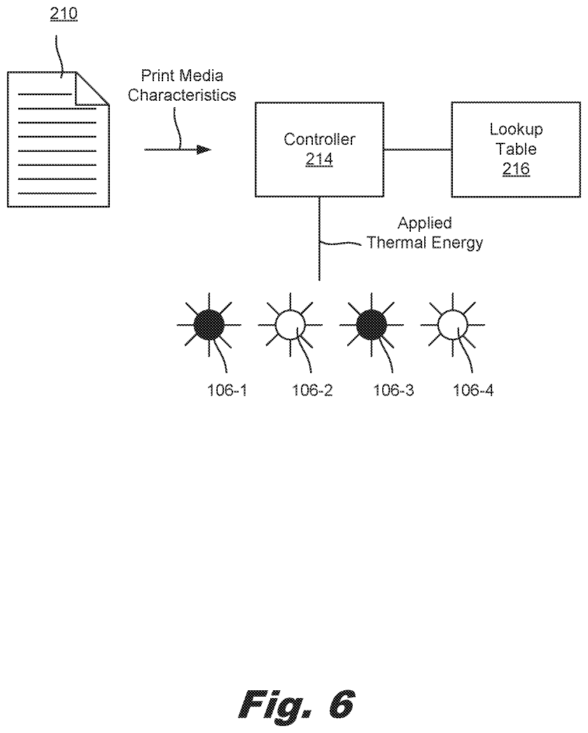

FIG. 6 is a diagram depicting independently controlling print heat sources (106), according to an example of the principles described herein. In the example depicted in FIG. 6, a first heat source (106-1) is a 100-watt heat lamp, a second heat source (106-2) is a 200-watt heat lamp, a third heat source (106-3) is a 400-watt heat lamp, and a fourth heat source (106-4) is an 800-watt heat lamp.

As described above, print media (210) characteristics may be measured for print media (210) that has been printed on and that is to pass to a print media conditioning system (FIG. 2, 208). The controller (214) receives this information, and consults the lookup table (216) to determine heat source (106) control information. In some examples, the information extracted from the lookup table (216) may include an overall thermal energy. In this example, the controller (204) may control heat sources (106) to emit the particular thermal energy. In other examples, the information extracted from the lookup table (216) may be some other value. In this example, the controller (204) may convert the other value into a combination of heat sources (106) to activate.

In either example, the controller (214) may determine that an overall thermal energy of 500 Watts is to be applied to the print media (210) or a portion thereof to effectuate a desired moisture removal amount. Accordingly, the controller (214) may activate the first heat source (106-1) which is a 100-watt heat source and the third source (106-3) which is a 400-watt heat source, thus resulting in an aggregated 500-watt of thermal energy as dictated by the print media characteristics and the lookup table (216). In other words, as a print job is analyzed by a processing system, print media (210) characteristics are determined, which print media (210) characteristics may be indicated as a rating or score. The score value will determine the appropriate amount of thermal energy to apply to the print job. This score may be passed to the controller (214) which activates the appropriate amount and combination of heat sources (106) based on the score-to-thermal energy mapping included in the lookup table (216). The print media (210) then enters the heating zone and is conditioned as it passes by the heat sources (106).

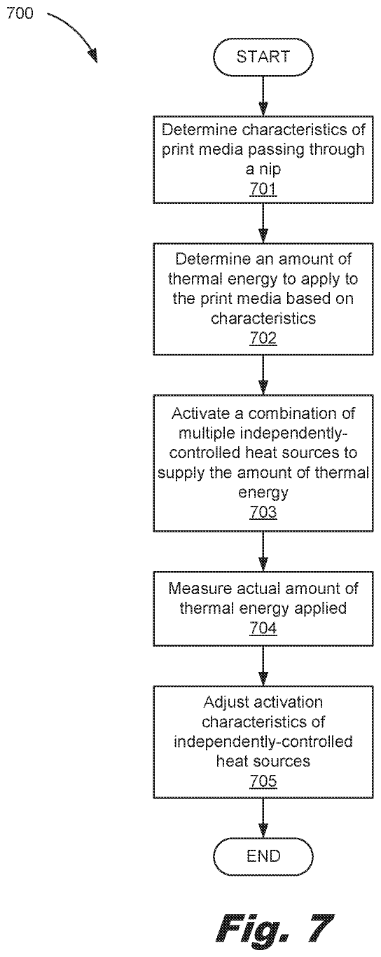

FIG. 7 is a flow chart of a method (700) for independently controlling print heat sources (FIG. 1, 106), according to another example of the principles described herein. According to the method (700), characteristics of print media (FIG. 2, 210) that is to pass through a nip of a print media conditioning system (FIG. 2, 208) are determined (block 701) and based on those conditions an amount of thermal energy to apply to the print media (FIG. 2, 210) is determined (block 702) and respective independently controlled heat sources (FIG. 1, 106) activated (block 703). These operations may be performed as described above in connection with FIG. 3.

Additional operations may also be executed. For example, actual amounts of thermal energy applied to the print media (FIG. 2, 210) may be measured (block 704). This may be done by the temperature sensor (FIG. 2, 218) as described above. This measured actual applied energy may be compared to a determined, or desired, amount of thermal energy to be applied. Based on the difference, activation characteristics for the multiple independently-controlled heat sources (FIG. 1, 106) may be adjusted (block 705). For example, different ones of the heat source (FIG. 1, 106) may be turned on or off. For example, if a 100-watt heat source (FIG. 1, 106) and a 400-watt heat source (FIG. 1, 106) are activated, but the measured actual amount of thermal energy applied is less than a desired amount of thermal energy applied, then the 100-watt heat source (FIG. 1, 106) may be turned off and the 200-watt heat source (FIG. 1, 106) may be turned to raise the temperature at the nip to the desired level.

Such systems and methods 1) reduce electrical flicker (i.e., cycling on/off); 2) enhance energy efficiency; 3) increase heat source life; 4) reduce over drying of print media causing undesired media curl; 5) provides a simple power control using discrete heat sources; 6) facilitates multiple quantized power levels achieved in fixed increments; 7) provides predetermined output levels; 8) are customizable to the specific characteristics of the input media content; 9) can continue operation in event of a single heat source failure; and 10) can be used with a variety of heat sources.

What is claimed is:

1. A print system, comprising;
a drive roller;
a heated transfer belt forming a nip with the drive roller, the heated transfer belt to transmit thermal energy to print media passing through the nip; and
multiple independently-controlled heat sources disposed within the heated transfer belt to transfer thermal energy to the heated transfer belt.

2. The print system of claim 1, further comprising a controller to:
determine an amount of thermal energy to apply to the print media based on characteristics of the print media; and
determine what combination of the multiple independently-controlled heat sources to activate to supply the determined amount of thermal energy.

3. The print system of claim 2, wherein the characteristics of the print media are selected from the group consisting of:
print media type;
print compound type;
an amount of print compound deposited; and
a location on the print media where the print compound is deposited.

4. The print system of claim 1, wherein at least one independently-controlled heat source extends a width of the heated transfer belt in a direction perpendicular to a media path.

5. The print system of claim 1, wherein a combined length of at least two independently-controlled heat sources is to extend a width of the heated transfer belt in a direction perpendicular to a media path.

6. The print system of claim 1, wherein at least two of the independently-controlled heat sources have different emitting energy values.

7. The print system of claim 6, wherein an independently-controlled heat source with a largest emitting energy value is farthest away from the nip relative to other independently-controlled heat sources.

8. The print system of claim 1 further comprising a temperature sensor to measure an applied thermal energy.

9. A method, comprising:
determining characteristics of print media passing through a nip between a drive roller and a heated transfer belt;
determining an amount of thermal energy to apply to the print media based on determined characteristics; and
activating a combination of multiple independently-controlled heat sources to supply a determined amount of thermal energy.

10. The method of claim 9, wherein determining characteristics of print media, determining an amount of thermal energy to apply to the print media, and activating a combination of the multiple independently-controlled heat sources is performed for each section of multiple sections of a sheet of print media.

11. The method of claim 9, further comprising:
measuring an actual amount of thermal energy applied to the print media; and
adjusting activation characteristics for the multiple independently-controlled heat sources based on a difference between a determined amount of thermal energy and a measured actual amount of thermal energy.

12. The method of claim 9, wherein at least one characteristic of the print media is determined based on user input.

13. A print media conditioning system, comprising:
a drive roller;
a heated transfer belt forming a nip with the drive roller, the heated transfer belt to transmit thermal energy to print media passing through the nip to dry liquid print compound on the print media;
multiple independently-controlled heat sources of varying emitting energy values disposed within the heated transfer belt to transfer thermal energy to the heated transfer belt;
a support member disposed within the heated transfer belt onto which the multiple independently-controlled heat sources are mounted;
a lookup table to map characteristics of the print media to amounts of thermal energy to apply to the print media; and
a controller to:
determine an amount of thermal energy to apply to the print media based on characteristics of the print media; and
determine what combination of the multiple independently-controlled heat sources to activate to supply the determined amount of thermal energy.

14. The print media conditioning system of claim 13, wherein the lookup table is based on:
environmental conditions of the print media conditioning system; and
a time delay between when the print media is printed on and when the print media passes through the nip.

15. The print media conditioning system of claim 13, wherein the heated transfer belt comprises a metallic tube:
coated on an outside diameter with a material with a low coefficient of friction; and
lined on an inside diameter with a rubber material.
